(19) United States
(12) Patent Application Publication
(10) Pub. No.: US 2016/0155428 A1
(43) Pub. Date: Jun. 2, 2016

(54) Method, apparatus and computer storage medium for displaying incoming call interface

(71) Applicant: ZTE CORPORATION, Guangdong (CN)

(72) Inventors: Guanghua Zhang, Shenzhen (CN); Honghua Gao, Shenzhen (CN); Desuo Wang, Shenzhen (CN)

(21) Appl. No.: 14/904,528

(22) PCT Filed: Apr. 25, 2014
(86) PCT No.: PCT/CN2014/076291

§ 371 Date: Jan. 12, 2016

(30) Foreign Application Priority Data
Jul. 15, 2013 (CN) 201310295731.9

(51) Int. Cl. G09G 5/38; G06F 3/0488; G06F 3/0484

(52) U.S. Cl. CPC G09G 5/38; G06F 3/04842; G06F 3/04847; G06F 3/04883; G06F 3/04845; G06F 3/04886; G09G 2340/0464; G09G 2320/0606

(57) ABSTRACT

Disclosed are a method, an apparatus and a computer storage medium for displaying an incoming call interface, and the method includes: acquiring a user click position when a call is received, the click position being regarded as a reference point of the incoming call interface; determining a display coordinate of the incoming call interface by using coordinate of the reference point; and displaying the incoming call interface according to the display coordinate when an incoming call is received, a click position where a user click is obtained, and the click position is set as a reference point for an incoming-call interface.

### TECHNICAL FIELD

The disclosure relates to the field of display control for mobile terminals, and in particular to a method and apparatus for displaying an incoming-call interface, and non-transitory computer-readable storage medium.

### BACKGROUND

In recent years, both hardware and software of a smart phone based on an Android operating system have been undergoing constant change. There have been great leaps in hardware configuration upgrading, from mono-core, dual-core, quad-core, to even eight-core configurations. A size of a screen of a smart phone may be up to 5.0 inch or more.

However, an overly large screen may also bring about some limitations and drawbacks for user operation. For example, in dialing, short message editing, answering an incoming call, it may be difficult for a user to both hold a mobile phone and operate an interface with a thumb simultaneously with only one hand. To solve such a problem, user interfaces of some large-screen mobile phones have been optimized. For example, an interface for receiving an incoming call may be set at an upper position, a lower position, a left position, or a right position. Although capable of relieving difficulty in one-hand operation, the solution of setting the four positions is somewhat inflexible.

### SUMMARY

To this end, embodiments herein provide a method and apparatus for displaying an incoming-call interface, and non-transitory computer-readable storage medium.

According to an embodiment herein, a method for displaying an incoming-call interface includes:

when receiving an incoming call, obtaining a click position where a user clicks, and setting the click position as a reference point for an incoming-call interface;

determining, using coordinates of the reference point, display coordinates for displaying the incoming-call interface; and

displaying the incoming-call interface according to the display coordinates.

The determining, using coordinates of the reference point, display coordinates for displaying the incoming-call interface may include: setting the reference point as a center of the incoming-call interface, a lower left corner of the incoming-call interface, a lower right corner of the incoming-call interface, an upper left corner of the incoming-call interface, an upper right corner of the incoming-call interface, a center of a lower edge of the incoming-call interface, a center of a right edge of the incoming-call interface, a center of a left edge of the incoming-call interface, or a center of an upper edge of the incoming-call interface; and

determining, using the coordinates of the reference point and a pre-set interfacial size, the display coordinates for displaying the incoming-call interface.

The pre-set interfacial size may be a length of the incoming-call interface and a width of the incoming-call interface.

The length of the incoming-call interface may be smaller than a length of a screen of a mobile terminal. The width of the incoming-call interface may be smaller than a width of the screen of the mobile terminal.

The display coordinates for displaying the incoming-call interface may include: a y-coordinate of the upper edge of the incoming-call interface, x-coordinates of a starting point and an ending point of the upper edge of the incoming-call interface, a y-coordinate of the lower edge of the incoming-call interface, x-coordinates of a starting point and an ending point of the lower edge of the incoming-call interface, y-coordinates of a starting point and an ending point of the left edge of the incoming-call interface, a x-coordinate of the left edge of the incoming-call interface, y-coordinates of a starting point and an ending point of the right edge of the incoming-call interface, and a x-coordinate of the right edge of the incoming-call interface.

The determining, using the coordinates of the reference point and a pre-set interfacial size, the display coordinates for displaying the incoming-call interface may include:

computing the coordinates of the edges of the incoming-call interface using the reference point and the pre-set interfacial size; determining whether the edges meet a requirement for display; when the edges meet the requirement for display, setting the coordinates of the edges of the incoming-call interface as the display coordinates for displaying the incoming-call interface;

otherwise when the edges do not meet the requirement for display, determining whether the upper edge and the lower edge meet the requirement for display, and determining whether the left edge and the right edge meet the requirement for display; when the upper edge and the lower edge do not meet the requirement for display, adjusting an x-coordinate of the centers of the upper edge and the lower edge to a designated x-coordinate without changing the y-coordinates of the upper edge and the lower edge; and setting the coordinates of the edges of the incoming-call interface as the display coordinates for displaying the incoming-call interface;

when the left edge and the right edge do not meet the requirement for display, adjusting a y-coordinate of the centers of the left edge and the right edge to a designated y-coordinate without changing the x-coordinates of the left edge and the right edge; and setting the coordinates of the edges of the incoming-call interface as the display coordinates for displaying the incoming-call interface.

According to an embodiment herein, an apparatus for displaying an incoming-call interface includes an interaction module and a control module.

The interaction module is configured for: when receiving an incoming call, obtaining a click position where a user clicks, and setting the click position as a reference point for an incoming-call interface, sending coordinates of the reference point to the control module, and displaying the incoming-call interface according to display coordinates sent by the control module.

The control module is configured for: determining, using the coordinates of the reference point sent by the interaction module, the display coordinates for displaying the incoming-call interface, and sending the display coordinates to the interaction module.

The control module may be configured for: setting the reference point as a center of the incoming-call interface, a lower left corner of the incoming-call interface, a lower right corner of the incoming-call interface, an upper left corner of the incoming-call interface, an upper right corner of the incoming-call interface, a center of a lower edge of the incoming-call interface, a center of a right edge of the incoming-call interface, a center of a left edge of the incoming-call interface, or a center of an upper edge of the incoming-call interface; and determining, using the coordinates of the reference point and a pre-set interfacial size, the display coordinates for displaying the incoming-call interface.

The control module may be configured for setting a length and a width of the incoming-call interface as the pre-set interfacial size. The length of the incoming-call interface may be smaller than a length of a screen of a mobile terminal. The width of the incoming-call interface may be smaller than a width of the screen of the mobile terminal.

The control module may be configured for: setting the display coordinates for displaying the incoming-call interface as a y-coordinate of the upper edge of the incoming-call interface, x-coordinates of a starting point and an ending point of the upper edge of the incoming-call interface, a y-coordinate of the lower edge of the incoming-call interface, x-coordinates of a starting point and an ending point of the lower edge of the incoming-call interface, y-coordinates of a starting point and an ending point of the left edge of the incoming-call interface, a x-coordinate of the left edge of the incoming-call interface, y-coordinates of a starting point and an ending point of the right edge of the incoming-call interface, and a x-coordinate of the right edge of the incoming-call interface.

The control module may be configured for: computing the coordinates of the edges of the incoming-call interface using the reference point and the pre-set interfacial size; determining whether the edges meet a requirement for display; when the edges meet the requirement for display, setting the coordinates of the edges of the incoming-call interface as the display coordinates for displaying the incoming-call interface;

otherwise when the edges do not meet the requirement for display. determining whether the upper edge and the lower edge meet the requirement for display, and determining whether the left edge and the right edge meet the requirement for display; when the upper edge and the lower edge do not meet the requirement for display, adjusting an x-coordinate of the centers of the upper edge and the lower edge to a designated x-coordinate without changing the y-coordinates of the upper edge and the lower edge; and setting the coordinates of the edges of the incoming-call interface as the display coordinates for displaying the incoming-call interface;

when the left edge and the right edge do not meet the requirement for display, adjusting a y-coordinate of the centers of the left edge and the right edge to a designated y-coordinate without changing the x-coordinates of the left edge and the right edge; and setting the coordinates of the edges of the incoming-call interface as the display coordinates for displaying the incoming-call interface.

According to an embodiment herein, a non-transitory computer-readable storage medium stores therein a computer executable program for executing the method for displaying an incoming-call interface.

With a method and apparatus for displaying an incoming-call interface, and non-transitory computer-readable storage medium according to embodiments herein, when an incoming call is received, a click position where a user clicks is obtained, and the click position is set as a reference point for an incoming-call interface; display coordinates for displaying the incoming-call interface are determined using coordinates of the reference point; the incoming-call interface is displayed according to the display coordinates. In this way, in case of an incoming call, it is not required to make a slide gesture on the large screen over an excessively long distance, but to click on a background interface to show the incoming-call interface such that a user may perform a subsequent operation. This may greatly facilitate single-hand operation by a user of a large-screen mobile phone and flexibly adapt to a gesture of holding the mobile phone as well as to both left-handed and right-handed users. A user may answer a call conveniently.

### BRIEF DESCRIPTION OF THE DRAWINGS

FIG. 1 is a flowchart of a method for displaying an incoming-call interface according to an embodiment herein.

FIG. 2 is a diagram of a structure of an apparatus for displaying an incoming-call interface according to an embodiment herein.

FIG. 3 is a flowchart according to a first embodiment herein.

FIG. 4 is a diagram of a click position in a screen and displaying an incoming-call interface according to the first embodiment herein.

FIG. 5 is another diagram of a click position in a screen and displaying an incoming-call interface according to the first embodiment herein.

### DETAILED DESCRIPTION

Implementation of embodiments herein is elaborated below with reference to drawings for a thorough understanding of features and technical content of the embodiments herein. The drawings herein are for reference and illustration only and are not intended for limiting the disclosure.

As shown in FIG. 1, a method for displaying an incoming-call interface according to an embodiment herein includes steps as follows.

In step S101, when an incoming call is received, a click position where a user clicks is obtained, and the click position is set as a reference point for an incoming-call interface.

When receiving an incoming call, a mobile terminal may display a prompt prompting the user to operate. The user may click, according to the prompt, on a position where to display the incoming-call interface on a screen of the mobile terminal. The click position where the user clicks may be set as the reference point for the incoming-call interface.

The prompt for operation may be configured for prompting the user to select the position where to display the incoming-call interface. For example, the prompt may be: click on area XX to display the incoming-call interface.

In step S102, display coordinates for displaying the incoming-call interface are determined using coordinates of the reference point.

The reference point of the incoming-call interface may be set as a center of the incoming-call interface, a lower left corner of the incoming-call interface, a lower right corner of the incoming-call interface, an upper left corner of the incoming-call interface, an upper right corner of the incoming-call interface, a center of a lower edge of the incoming-call interface, a center of a right edge of the incoming-call interface, a center of a left edge of the incoming-call interface, or a center of an upper edge of the incoming-call interface. The display coordinates for displaying the incoming-call interface may be determined using the coordinates of the reference point and a pre-set interfacial size.

The pre-set interfacial size may be a length of the incoming-call interface and a width of the incoming-call interface. The length of the incoming-call interface may be smaller than a length of a screen of a mobile terminal. The width of the incoming-call interface may be smaller than a width of the screen of the mobile terminal.

The display coordinates for displaying the incoming-call interface may include: a y-coordinate of the upper edge of the incoming-call interface, x-coordinates of a starting point and an ending point of the upper edge of the incoming-call interface, a y-coordinate of the lower edge of the incoming-call interface, x-coordinates of a starting point and an ending point of the lower edge of the incoming-call interface, y-coordinates of a starting point and an ending point of the left edge of the incoming-call interface, a x-coordinate of the left edge of the incoming-call interface, y-coordinates of a starting point and an ending point of the right edge of the incoming-call interface, and a x-coordinate of the right edge of the incoming-call interface.

The display coordinates for displaying the incoming-call interface may be determined using the coordinates of the reference point and the pre-set interfacial size as follows.

The coordinates of the edges of the incoming-call interface may be computed using the reference point and the pre-set interfacial size. It may be determined whether the edges meet a requirement for display. When the edges meet the requirement for display, the coordinates of the edges of the incoming-call interface may be set as the display coordinates for displaying the incoming-call interface.

Otherwise when the edges do not meet the requirement for display, it may be determined whether the upper edge and the lower edge meet the requirement for display, and/or whether the left edge and the right edge meet the requirement for display. When the upper edge and the lower edge do not meet the requirement for display, an x-coordinate of the centers of the upper edge and the lower edge may be adjusted to a designated x-coordinate without changing the y-coordinates of the upper edge and the lower edge; and the coordinates of the edges of the incoming-call interface may be set as the display coordinates for displaying the incoming-call interface.

When the left edge and the right edge do not meet the requirement for display, a y-coordinate of the centers of the left edge and the right edge may be adjusted to a designated y-coordinate without changing the x-coordinates of the left edge and the right edge; and the coordinates of the edges of the incoming-call interface may be set as the display coordinates for displaying the incoming-call interface.

The coordinates of the edges of the incoming-call interface may be computed using the reference point and the pre-set interfacial size according to related art, which is not repeated here.

When a lower left corner of the screen is set as an origin, the designated x-coordinate may be half of the width of the incoming-call interface in the pre-set interfacial size. Alternatively, the designated x-coordinate may also be the width of the mobile terminal minus half of the width of the incoming-call interface.

When the lower left corner of the screen is used as the origin, the designated y-coordinate may be half of the length of the incoming-call interface in the pre-set interfacial size. Alternatively, the designated y-coordinate may also be the length of the mobile terminal minus half of the length of the incoming-call interface.

In step S103, the incoming-call interface is displayed according to the display coordinates.

Content of the incoming-call interface may be identical to related art. For example, the incoming-call interface may contain an answer key, a refuse key, and/or the like. Such content is not repeated here.

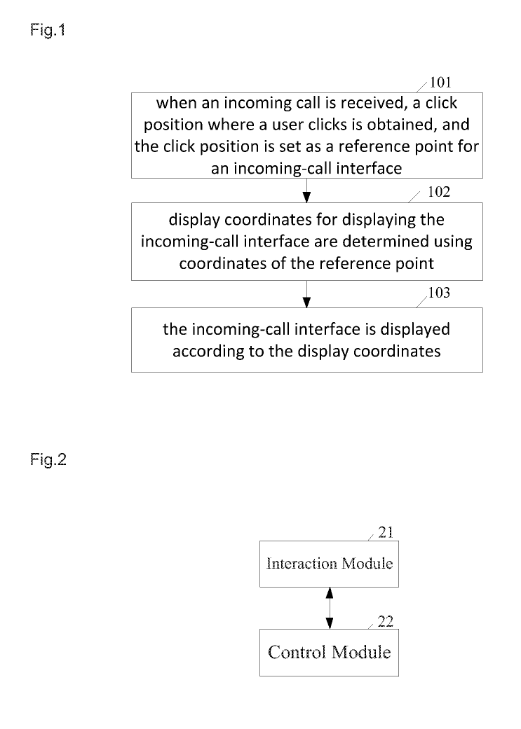

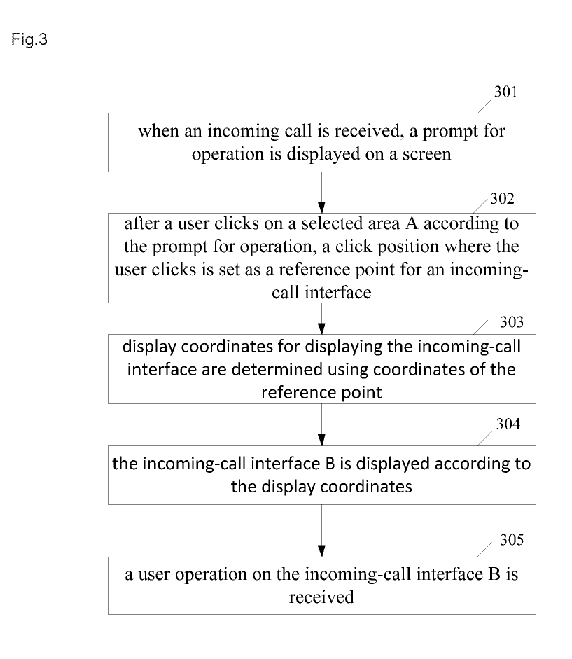

As shown in FIG. 2, an apparatus for displaying an incoming-call interface according to an embodiment herein includes an interaction module 21 and a control module 22.

The interaction module 21 is configured for: when receiving an incoming call, obtaining a click position where a user clicks, and setting the click position as a reference point for an incoming-call interface, sending coordinates of the reference point to the control module 22, and displaying the incoming-call interface according to display coordinates sent by the control module 22.

The control module 22 is configured for: determining, using the coordinates of the reference point sent by the interaction module 21, the display coordinates for displaying the incoming-call interface, and sending the display coordinates to the interaction module 21.

The interaction module 21 may be configured for displaying a prompt prompting the user to operate. The user may click, according to the prompt, on a position where to display the incoming-call interface. The click position where the user clicks may be set as the reference point for the incoming-call interface.

The prompt for operation may be configured for prompting the user to select the position where to display the incoming-call interface. For example, the prompt may be: click on area XX to display the incoming-call interface.

The control module 22 may be configured for: setting the reference point as a center of the incoming-call interface, a lower left corner of the incoming-call interface, a lower right corner of the incoming-call interface, an upper left corner of the incoming-call interface, an upper right corner of the incoming-call interface, a center of a lower edge of the incoming-call interface, a center of a right edge of the incoming-call interface, a center of a left edge of the incoming-call interface, or a center of an upper edge of the incoming-call interface; and determining, using the coordinates of the reference point and a pre-set interfacial size, the display coordinates for displaying the incoming-call interface.

The control module 22 may be configured for: setting a length and a width of the incoming-call interface as the pre-set interfacial size. The length of the incoming-call interface may be smaller than a length of a screen of a mobile terminal. The width of the incoming-call interface may be smaller than a width of the screen of the mobile terminal.

The control module 22 may be configured for: setting the display coordinates for displaying the incoming-call interface as a y-coordinate of the upper edge of the incoming-call interface, x-coordinates of a starting point and an ending point of the upper edge of the incoming-call interface, a y-coordinate of the lower edge of the incoming-call interface, x-coordinates of a starting point and an ending point of the lower edge of the incoming-call interface, y-coordinates of a starting point and an ending point of the left edge of the incoming-call interface, a x-coordinate of the left edge of the incoming-call interface, y-coordinates of a starting point and an ending point of the right edge of the incoming-call interface, and a x-coordinate of the right edge of the incoming-call interface.

The control module 22 may be configured for: computing the coordinates of the edges of the incoming-call interface using the reference point and the pre-set interfacial size; determining whether the edges meet a requirement for display; when the edges meet the requirement for display, setting the coordinates of the edges of the incoming-call interface as the display coordinates for displaying the incoming-call interface;

otherwise when the edges do not meet the requirement for display, determining whether the upper edge and the lower edge meet the requirement for display, and determining whether the left edge and the right edge meet the requirement for display; when the upper edge and the lower edge do not meet the requirement for display, adjusting an x-coordinate of the centers of the upper edge and the lower edge to a designated x-coordinate without changing the y-coordinates of the upper edge and the lower edge; and setting the coordinates of the edges of the incoming-call interface as the display coordinates for displaying the incoming-call interface;

when the left edge and the right edge do not meet the requirement for display, adjusting a y-coordinate of the centers of the left edge and the right edge to a designated y-coordinate without changing the x-coordinates of the left edge and the right edge; and setting the coordinates of the edges of the incoming-call interface as the display coordinates for displaying the incoming-call interface.

The apparatus for displaying an incoming-call interface may be installed in a mobile terminal. The interaction module 21 may be a touch screen in the apparatus. The control module 22 may be a processor of the apparatus.

When implemented in form of a software functional module and sold or used as an independent product, the interaction module 21 and the control module 22 according to an embodiment herein may also be stored in a non-transitory computer-readable storage medium. Based on such an understanding, the essential part or a part contributing to prior art of the technical solution of an embodiment herein may appear in form of a software product, which software product is stored in storage media, and includes a number of instructions for allowing a computer equipment (such as a personal computer, a server, a network equipment, and/or the like) to execute all or part of the methods in various embodiments of the present disclosure. The storage media include various media that can store program codes such as a U disk, a mobile hard disk, a Read Only Memory (ROM), a magnetic disk, a CD, and/or the like. Thus, an embodiment herein is not limited to any specific combination of hardware and software.

Accordingly, an embodiment herein may also provide a non-transitory computer-readable storage medium including a computer program for executing the method for displaying an incoming-call interface.

### First Embodiment

In step S301, when an incoming call is received, a prompt for operation is displayed on a screen.

For example, the prompt may be: click on area XX to display the incoming-call interface.

In step S302, after a user clicks on a selected position A according to the prompt for operation, the click position where the user clicks is set as a reference point for an incoming-call interface.

In step S303, display coordinates for displaying the incoming-call interface are determined using coordinates of the reference point.

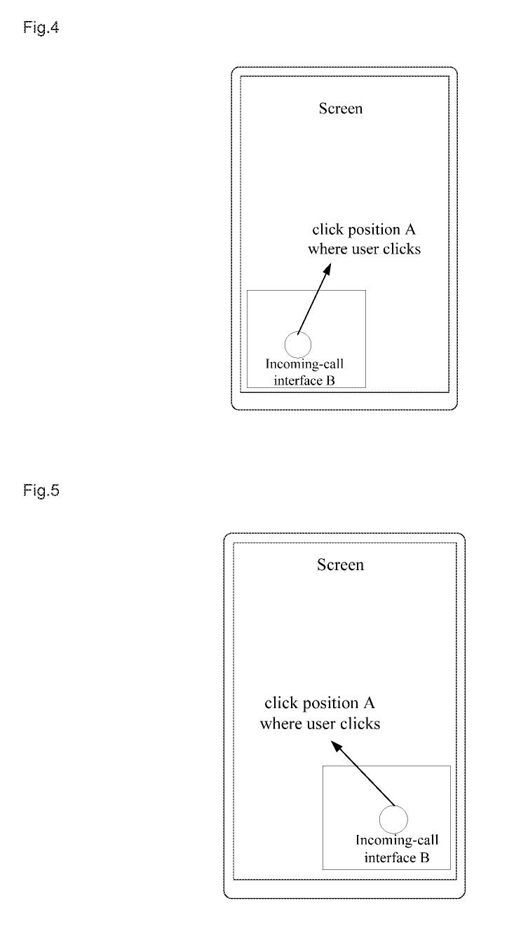

For example, as shown in FIG. 4 or FIG. 5, when a user clicks a position A, incoming-call interface B may appear. Assume that the width of the screen of the mobile phone is Lphone, and the width of the incoming-call interface B is Lb. Lphone=Lb is adopted in most mobile phones presently on the market. However for a large-screen mobile phone, this will lead to a user interface too large for a user to operate on with ease. In practice, Lb may be made less than Lphone by being given an appropriate empirical value. An interface of the empirical width Lb may allow the user to operate on the interface with a single hand.

The lower left corner of the screen of the mobile phone may be set as the origin. The positive direction of the x axis may be to the right. When the user clicks on a position A, an interface B centered on point A may appear. The x-coordinate of point A may be set as xa. Then, it may be possible that (xa+Lb/2)>Lphone (namely, the user has clicked on a position that is too close to the right edge of the screen), or that (xa−Lb/2)<0 (namely, the user has clicked on a position that is too close to the left edge of the screen). In such a case, the x-coordinate of the center of the interface B may be set as Lb/2 or (Lphone−Lb/2) instead of the x-coordinate of point A.

Likewise, similar processing may be performed in the Y-axis direction.

In step 304, the incoming-call interface B is displayed according to the display coordinates.

In step 305, a user operation on the incoming-call interface B may be received.

Although operation on the incoming-call interface B is consistent with that of an existing mobile phone, the incoming-call interface B is advantageous in that a position where the incoming-call interface B may appear is to some extent user-controllable and that the incoming-call interface B may be smaller in size than the screen of the mobile phone, adapted to being operated by the user with a single hand.

Clearly, in case of an incoming call, when answering the call, the user is not required to make a slide gesture on the large screen over an excessively long distance, but to click on a background interface to show the incoming-call interface so as to perform a subsequent operation. This may greatly facilitate single-hand operation by a user of a large-screen mobile phone and flexibly adapt to a gesture of holding the mobile phone as well as to both left-handed and right-handed users.

What described are merely embodiments of the disclosure and are not intended for limiting the protection scope of the disclosure.

1. A method for displaying an incoming-call interface, comprising:
when receiving an incoming call, obtaining a click position where a user clicks, and setting the click position as a reference point for an incoming-call interface;
determining, using coordinates of the reference point, display coordinates for displaying the incoming-call interface; and
displaying the incoming-call interface according to the display coordinates.

2. The method according to claim 1, wherein the determining, using coordinates of the reference point, display coordinates for displaying the incoming-call interface comprises: setting the reference point as a center of the incoming-call interface, a lower left corner of the incoming-call interface, a lower right corner of the incoming-call interface, an upper left corner of the incoming-call interface, an upper right corner of the incoming-call interface, a center of a lower edge of the incoming-call interface, a center of a right edge of the incoming-call interface, a center of a left edge of the incoming-call interface, or a center of an upper edge of the incoming-call interface; and
determining, using the coordinates of the reference point and a pre-set interfacial size, the display coordinates for displaying the incoming-call interface.

3. The method according to claim 2, wherein the pre-set interfacial size is: a length of the incoming-call interface and a width of the incoming-call interface,
wherein the length of the incoming-call interface is smaller than a length of a screen of a mobile terminal, and the width of the incoming-call interface is smaller than a width of the screen of the mobile terminal.

4. The method according to claim 3, wherein the display coordinates for displaying the incoming-call interface comprises: a y-coordinate of the upper edge of the incoming-call interface, x-coordinates of a starting point and an ending point of the upper edge of the incoming-call interface, a y-coordinate of the lower edge of the incoming-call interface, x-coordinates of a starting point and an ending point of the lower edge of the incoming-call interface, y-coordinates of a starting point and an ending point of the left edge of the incoming-call interface, a x-coordinate of the left edge of the incoming-call interface, y-coordinates of a starting point and an ending point of the right edge of the incoming-call interface, and a x-coordinate of the right edge of the incoming-call interface.

5. The method according to claim 4, wherein the determining, using the coordinates of the reference point and a pre-set interfacial size, the display coordinates for displaying the incoming-call interface comprises:
computing the coordinates of the edges of the incoming-call interface using the reference point and the pre-set interfacial size; determining whether the edges meet a requirement for display; when the edges meet the requirement for display, setting the coordinates of the edges of the incoming-call interface as the display coordinates for displaying the incoming-call interface;
otherwise when the edges do not meet the requirement for display, determining whether the upper edge and the lower edge meet the requirement for display, and determining whether the left edge and the right edge meet the requirement for display; when the upper edge and the lower edge do not meet the requirement for display, adjusting an x-coordinate of the centers of the upper edge and the lower edge to a designated x-coordinate without changing the y-coordinates of the upper edge and the lower edge; and setting the coordinates of the edges of the incoming-call interface as the display coordinates for displaying the incoming-call interface;
when the left edge and the right edge do not meet the requirement for display, adjusting a y-coordinate of the centers of the left edge and the right edge to a designated y-coordinate without changing the x-coordinates of the left edge and the right edge; and setting the coordinates of the edges of the incoming-call interface as the display coordinates for displaying the incoming-call interface.

6. An apparatus for displaying an incoming-call interface, comprising an interaction module and a control module, wherein
the interaction module is configured for: when receiving an incoming call, obtaining a click position where a user clicks, and setting the click position as a reference point for an incoming-call interface, sending coordinates of the reference point to the control module, and displaying the incoming-call interface according to display coordinates sent by the control module; and
the control module is configured for: determining, using the coordinates of the reference point sent by the interaction module, the display coordinates for displaying the incoming-call interface, and sending the display coordinates to the interaction module.

7. The apparatus according to claim 6, wherein the control module is configured for:
setting the reference point as a center of the incoming-call interface, a lower left corner of the incoming-call interface, a lower right corner of the incoming-call interface, an upper left corner of the incoming-call interface, an upper right corner of the incoming-call interface, a center of a lower edge of the incoming-call interface, a center of a right edge of the incoming-call interface, a center of a left edge of the incoming-call interface, or a center of an upper edge of the incoming-call interface; and
determining, using the coordinates of the reference point and a pre-set interfacial size, the display coordinates for displaying the incoming-call interface.

8. The apparatus according to claim 7, wherein
the control module is configured for: setting a length and a width of the incoming-call interface as the pre-set interfacial size, wherein the length of the incoming-call interface is smaller than a length of a screen of a mobile terminal, and the width of the incoming-call interface is smaller than a width of the screen of the mobile terminal.

9. The apparatus according to claim 8, wherein
the control module is configured for: setting the display coordinates for displaying the incoming-call interface as a y-coordinate of the upper edge of the incoming-call interface, x-coordinates of a starting point and an ending point of the upper edge of the incoming-call interface, a y-coordinate of the lower edge of the incoming-call interface, x-coordinates of a starting point and an ending point of the lower edge of the incoming-call interface, y-coordinates of a starting point and an ending point of the left edge of the incoming-call interface, a x-coordinate of the left edge of the incoming-call interface, y-coordinates of a starting point and an ending point of the right edge of the incoming-call interface, and a x-coordinate of the right edge of the incoming-call interface.

10. The apparatus according to claim 9, wherein the control module is configured for:
computing the coordinates of the edges of the incoming-call interface using the reference point and the pre-set interfacial size; determining whether the edges meet a requirement for display; when the edges meet the requirement for display, setting the coordinates of the edges of the incoming-call interface as the display coordinates for displaying the incoming-call interface;
otherwise when the edges do not meet the requirement for display, determining whether the upper edge and the lower edge meet the requirement for display, and determining whether the left edge and the right edge meet the requirement for display; when the upper edge and the lower edge do not meet the requirement for display, adjusting an x-coordinate of the centers of the upper edge and the lower edge to a designated x-coordinate without changing the y-coordinates of the upper edge and the lower edge; and setting the coordinates of the edges of the incoming-call interface as the display coordinates for displaying the incoming-call interface;
when the left edge and the right edge do not meet the requirement for display, adjusting a y-coordinate of the centers of the left edge and the right edge to a designated y-coordinate without changing the x-coordinates of the left edge and the right edge; and setting the coordinates of the edges of the incoming-call interface as the display coordinates for displaying the incoming-call interface.

11. A non-transitory computer-readable storage medium, comprising computer executable instructions for executing a method for displaying an incoming call interface, the method comprising:
when receiving an incoming call, obtaining a click position where a user clicks, and setting the click position as a reference point for an incoming call interface;
determining, using coordinates of the reference point, display coordinates for displaying the incoming-call interface; and
displaying the incoming-call interface according to the display coordinates.

12. The storage medium according to claim 11, wherein the determining, using coordinates of the reference point, display coordinates for displaying the incoming-call interface comprises: setting the reference point as a center of the incoming-call interface, a lower left corner of the incoming-call interface, a lower right corner of the incoming-call interface, an upper left corner of the incoming-call interface, an upper right corner of the incoming-call interface, a center of a lower edge of the incoming-call interface, a center of a right edge of the incoming-call interface, a center of a left edge of the incoming-call interface, or a center of an upper edge of the incoming-call interface; and
determining, using the coordinates of the reference point and a pre-set interfacial size, the display coordinates for displaying the incoming-call interface.

13. The storage medium according to claim 12, wherein the pre-set interfacial size is: a length of the incoming-call interface and a width of the incoming-call interface,
wherein the length of the incoming-call interface is smaller than a length of a screen of a mobile terminal, and the width of the incoming-call interface is smaller than a width of the screen of the mobile terminal.

14. The storage medium according to claim 13, wherein the display coordinates for displaying the incoming-call interface comprises: a y-coordinate of the upper edge of the incoming-call interface, x-coordinates of a starting point and an ending point of the upper edge of the incoming-call interface, a y-coordinate of the lower edge of the incoming-call interface, x-coordinates of a starting point and an ending point of the lower edge of the incoming-call interface, y-coordinates of a starting point and an ending point of the left edge of the incoming-call interface, a x-coordinate of the left edge of the incoming-call interface, y-coordinates of a starting point and an ending point of the right edge of the incoming-call interface, and a x-coordinate of the right edge of the incoming-call interface.

15. The storage medium according to claim 14, wherein the determining, using the coordinates of the reference point and a pre-set interfacial size, the display coordinates for displaying the incoming-call interface comprises:
computing the coordinates of the edges of the incoming-call interface using the reference point and the pre-set interfacial size; determining whether the edges meet a requirement for display; when the edges meet the requirement for display, setting the coordinates of the edges of the incoming-call interface as the display coordinates for displaying the incoming-call interface;
otherwise when the edges do not meet the requirement for display, determining whether the upper edge and the lower edge meet the requirement for display, and determining whether the left edge and the right edge meet the requirement for display; when the upper edge and the lower edge do not meet the requirement for display, adjusting an x-coordinate of the centers of the upper edge and the lower edge to a designated x-coordinate without changing the y-coordinates of the upper edge and the lower edge; and setting the coordinates of the edges of the incoming-call interface as the display coordinates for displaying the incoming-call interface;
when the left edge and the right edge do not meet the requirement for display, adjusting a y-coordinate of the centers of the left edge and the right edge to a designated y-coordinate without changing the x-coordinates of the left edge and the right edge; and setting the coordinates of the edges of the incoming-call interface as the display coordinates for displaying the incoming-call interface.
